(19) United States
(12) Patent Application Publication
(10) Pub. No.: US 2005/0033667 A1
(43) Pub. Date: Feb. 10, 2005

(54) Method for selling approved material

(75) Inventors: Yoshiyuki Sugimoto, Kawasaki-shi (JP); Sei Fujita, Yokohama-shi (JP); Yoshiyuki Tanaka, Itabashi-ku (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignees: LINTEC Corporation, Tokyo (JP); PRINTEC Corporation, Tokyo (JP)

(21) Appl. No.: 10/901,853

(22) Filed: Jul. 28, 2004

(30) Foreign Application Priority Data
Aug. 4, 2003 (JP) 2003-286015

(51) Int. Cl. G06F 17/60

(52) U.S. Cl. 705/28; 705/40

(57) ABSTRACT

In a method for selling an approved material, the amounts of each material forwarded to and used by each customer are input into a computer, and the updated amount of inventory of the material in the customer is recorded. The computer checks the amounts of inventory and the used amount when issuance of an approved material certificate is requested from a customer having an ID number and a password through a network communication. When the used amount does not exceed the amount of inventory, issuance of the approved material certificate is approved, and the used amount is subtracted from the amount of inventory to update the amount of inventory. When the used amount exceeds the amount of inventory, the issuance is disapproved. When an approved material is sold and issuance of the approved material certificate is requested through a network communication, approval or disapproval is decided quickly and accurately.

### BACKGROUND OF THE INVENTION

1. Field of the Invention

The present invention relates to a method for selling an approved material. More particularly, the present invention relates to a method for selling an approved sheet material wherein, when a material approved by a public organization such as wall materials and interior materials approved with respect to the fire prevention or the flame resistance is sold, a request for issuance of an approved material certificate is received through a network communication, the amount of inventory in the customer and the amount used by the customer are checked, and approval or disapproval of the issuance of the approved material certificate is decided quickly and accurately.

2. Description of Related Art

Sheet materials for digital prints are being widely used since interior materials having original designs can be produced in small amounts and a great freedom is provided to designing in that, for example, data of figures such as characters, logotypes and illustrations and images of pictures can be attached. As for the interior materials for buildings, the use of the interior materials is restricted depending on the object of the use of the building, the area of the floor and the type of the space such as the living room and the passage, and it is required by the Japanese Building Standards Act that designated materials such as fireproof materials, quasi-fireproof materials and flame retarded materials be used. Therefore, fire prevention materials which pass the test of performance evaluation by designated organizations for performance evaluation and are approved by the Minister of Land, Infrastructure and Transport have been developed as sheet materials used for the interior materials.

A sheet material used for digital prints is forwarded from a manufacturer of the sheet material to an output processors who is a customer of the manufacturer. The customer produces digital prints of figures using a digital printer or the like based on an order from a user, and the product is forwarded and processed. When the construction is completed, the examination by the fire department is conducted, and it is required for the materials used for the interior that the approved material certificate describing the type of the material and the name and the location of the works or the building be submitted. For this purpose, the customer sends a request specifically describing in detail the name of the works or the construction, the location of the works or the construction, the name of the used printer, the name of the contractor, the amount of the used material, the portion of the working, the date of completion and the material of the substrate, and requests the issuance of the approved material certificate. The manufacturer of the sheet material calculates the amount of inventory of the approved sheet material in the customer based on the amount of the approved sheet material forwarded to the customer and the amount of the approved sheet material used by the customer, and it is confirmed that the amount used in the present case does not contradicts the amount of inventory. The manufacturer issues the approved material certificate based on the confirmation. However, since the number of the customers who are output processors of the approved sheet material for digital prints is great, and the type of the approved sheet material is as diverse as, for example, fireproof materials, quasi-fireproof materials and flame retarding materials conforming to the Japanese Building Standards Act, flame resistant materials conforming to the Japanese Fire Protection Law and materials preventing the Sick House Syndrome conforming to the Japanese Building Standard Act, a great labor is required to decide the approval or the disapproval of the issuance of the approved material certificate.

### SUMMARY OF THE INVENTION

The present invention has an object of providing a method for selling an approved sheet material wherein, when a material approved by a public organization such as wall materials and interior materials approved with respect to the fire prevention or the flame resistance is sold, a request for issuance of an approved material certificate is received through a network communication, the amount of inventory in the customer and the amount used by the customer are checked, and approval or disapproval of the issuance of the approved material certificate is decide quickly and accurately.

As the result of extensive studies by the present inventors to overcome the above problem, it was found that the required treatment could be conducted rapidly and accurately on a great number of customers and variety of approved sheet materials by providing an ID number and a password to each customer of each approved sheet material used for digital prints, checking the amount of inventory in the customer and the amount used by the customer by a computer when the request for issuance of an approved material certificate was received from the customer having the ID number and the password through a network communication such as the internet, and deciding the approval or the disapproval of the issuance. The present invention was completed based on this knowledge.

The present invention provides:
(1) A method for selling an approved material which comprises, using a computer for inputting an amount of the approved material forwarded to a customer and an amount of the approved material used by the customer with respect to every customer and every brand and recording an updated amount of inventory of the approved material in the customer,
   when a request for issuance of an approved material certificate is received from a customer having an ID number and a password through a network communication, checking an amount of inventory of the approved material in the customer and an amount of the approved material used by the customer by the computer;
   when the amount used by the customer does not exceed the amount of inventory, outputting a signal of approving the issuance of the approved material certificate, and recording an updated amount of inventory which is obtained by subtracting the amount used by the customer from the amount of inventory; and
   when the used amount exceeds the amount of inventory, outputting a signal of disapproving the issuance of the approved material certificate;
(2) A method for selling an approved material according to (1), wherein the approved material is a fire prevention material conforming to a building standard of an organization;
(3) A method for selling an approved material according to (2), wherein the building standard is the Japanese Building Standards Act;
(4) A method for selling an approved material according to (1), wherein the approved material is a flame resistant material conforming to a fire protection law;
(5) A method for selling an approved material according to (4), wherein the fire protection law is the Japanese Fire Protection Law;
(6) A method for selling an approved material according to (1), wherein the approved material is a material preventing Sick House Syndrome conforming to a building standard;
(7) A method for selling an approved material according to (6), wherein the building standard is the Japanese Building Standards Act;
(8) A method for selling an approved material according to (1), wherein the approved material is a material having an assured quality based on a rule in a company;
(9) A method for selling an approved material according to (1), wherein, when a first order is received from a customer, an ID number and a password are provided to the customer, the approved material is forwarded to the customer, and an amount forwarded to the customer is recorded in the computer;
(10) A method for selling an approved material according to (1), wherein the approved material is a material used for digital prints;
(11) A method for selling an approved material according to (2), wherein the approved material is a material used for digital prints;
(12) A method for selling an approved material according to (4), wherein the approved material is a material used for digital prints;
(13) A method for selling an approved material according to (6), wherein the approved material is a material used for digital prints;
(14) A method for selling an approved material according to (8), wherein the approved material is a material used for digital prints;
(15) A method for selling an approved material according to (9), wherein the approved material is a material used for digital prints;
(16) A method for selling an approved material according to (1), wherein the approved material is a sheet material;
(17) A method for selling an approved material according to (2), wherein the approved material is a sheet material;
(18) A method for selling an approved material according to (4), wherein the approved material is a sheet material;
(19) A method for selling an approved material according to (6), wherein the approved material is a sheet material;
(20) A method for selling an approved material according to (8), wherein the approved material is a sheet material;
(21) A method for selling an approved material according to (9), wherein the approved material is a sheet material; and
(22) A method for selling an approved material according to (10), wherein the approved material is a sheet material.

### BRIEF DESCRIPTION OF THE DRAWINGS

FIG. 1(a) and FIG. 1(b) show a flow diagram of an embodiment of the method of the present invention. FIG. 2(a) and FIG. (b) show a sample of certificate of approved fire prevention wall material. FIG. 3 shows a sample of approval label.

### DESCRIPTION OF THE PREFERRED EMBODIMENTS

In accordance with the method for selling an approved material of the present invention, a computer for inputting the amount of the approved material forwarded to a customer and the amount of the approved material used by the customer with respect to every customer and every brand and recording the updated amount of inventory of the approved material in the customer, is used. The amount of inventory of the approved material in the customer and the amount of the approved material used by the customer are checked by the computer when a request for issuance of an approved material certificate is received from a customer having the ID number and the password through a network communication. When the amount used by the customer does not exceed the amount of inventory, a signal of approving the issuance of the approved material certificate is output, and the updated amount of inventory which is obtained by subtracting the used amount from the amount of inventory is recorded. When the used amount exceeds the amount of inventory, a signal of disapproving the issuance of the approved material certificate is output.

In the method of the present invention, the customer is, for example, a person conducting output processing who purchases a blank approved sheet material from a manufacturer of the approved sheet material, prepares a design of an interior material through discussion with users such as the contractor and the user who orders the operation, creates data for digital prints by processing the prepared design, produces the prints on the blank material by outputting the data using an ink jet printer or the like, laminates a protective film on the produced prints and carries out works on an article of the user using the obtained product by himself or through another agent.

The approved material of this invention means any material which has been approved by any organization or party which gives approvals for the safety of quality of a material used under the control of the organization or party in accordance with, for example, laws, rules, regulations or other criteria prescribed by said party to ensure the safety or quality of said material. Aforesaid organization or party may include a government of a country, state or any subordinate organization thereof, and any official party such as local self-governing body, a nonprofit organization, a private enterprise, an organization being organized by a group of such enterprises.

The approved material in the present invention is not particularly limited as long as the amount of the material can be known. Examples of the material include fireproof decorative sheets, flame retarded plywood boards, fireproof decorative boards, flame retarded coating materials, stainless steel welding materials for building structures, mechanical joints for trusses and force bearing walls for wooden pillar-and-beam structures approved by the Ministry of Land of Japan, Infrastructure and Transport, flame resistant plywood boards approved by the Fire and Disaster Management Agency of Japan, flame retarded materials for clean rooms approved by the Factory Mutual System of the United States of America and organic materials approved by the Ecosert of France.

The preferred embodiments will be described with reference to approved sheet materials in the following. The material used for the approved sheet material is not particularly limited. Examples of the material include paper, plastic films, plastic sheets, cloth and thin films of metal. As for the approved sheet material, the method of the present invention can be applied to any of materials which have an adhesive layer and can be used for working directly after removing a release sheet and materials which have no adhesives and can be used for working after being coated with an adhesive. The application of the approved sheet material used in the method of the present invention is not particularly limited. Examples of the application include wall materials for living rooms, corridors, stairways, passages, doors and elevators, ceiling materials, floor materials, curtains, roll screens and decorative materials such as signs, displays and billboards.

In the method of the present invention, the type of approval of the approved sheet material is not particularly limited. Examples of the type of approval include approvals for materials approved by public organizations such as fireproof materials, quasi-fireproof materials, flame retarded materials and materials preventing the Sick House Syndrome approved by the Minister of Land, Infrastructure and Transport based on the Japanese Building Standards Act, flame resistant materials approved by the Fire and Disaster Management Agency based on the Japanese Fire Protection Law, fire resistant materials for ships and boats approved by the District Transport Bureau, materials approved by private organizations such as flame retarded materials approved by the NIPPON KAIJI KYOKAI, and materials the quality of which is assured by private companies for customers based on quality standards within the companies. Even when a material is not regulated by a rule of approval at the present, the method of the present invention can be applied to the material in future when a novel rule of approval is decided due to a change in laws and rules of regulation and the approval is required for the material. It is preferable that the sheet material is approved not as the material alone but as the final commercial product of an interior material or a wall material including ink for output images, protective films, adhesive layers and the substrate (an adherent).

In the method of the present invention, a computer for inputting the amount of the approved sheet material forwarded to a customer and the amount of the approved sheet material used by the customer and recording the updated amount of inventory of the approved sheet material in the customer, is used. When a request for issuance of an approved material certificate is received from the customer having the ID number and the password through a network communication, the amount of inventory of the approved sheet material in the customer and the amount of the approved sheet material used by the customer are checked by the computer. The network communication means a communication system in which a plurality of computer systems are connected through a network circuit. In the method of the present invention, the network communication connects computers of the seller and the customers and includes the internet and the direct communication through the telephone line. In the request for the approved material certificate by a customer through the network communication, the amount used by the customer is contained in combination with the type and the brand of the used approved sheet material, the name and the location of the works or the building, the used printer, the name of the company in charge of the working and the portions of the working. The method for inputting the amount forwarded to the customer into the computer is not particularly limited. For example, when an order is received from a customer having the ID number and the password through the network communication, the direction of the forwarding is output from the computer, and the amount of inventory is updated by adding the newly forwarded amount to the former amount of inventory within the computer. When the order is received from a customer through facsimile or through another agent, the information can be input at the terminal. As for the input of the amount used by a customer into the computer, when the request for issuance of the approved material certificate is received from the customer having the ID number and the password, the amount used by the customer which is contained in the request is processed in the computer, and the amount of inventory is updated by subtracting the used amount from the former amount of inventory.

In the method of the present invention, when the request for issuance of the approved material certificate is received from a customer having the ID number and the password, the amount of inventory of the approved sheet material in the customer and the amount of the approved sheet material used by the customer are checked by the computer. When the amount used by the customer does not exceed the amount of inventory, a signal of approving the issuance of the approved material certificate is output, and the updated amount of inventory which is obtained by subtracting the used amount from the amount of inventory is recorded. When the signal of approving the issuance of the approved material certificate is output, the person in charge of the issuance of the approved sheet material in the manufacturer issues the approved material certificate describing information of the product such as the type, the brand and the construction of the material, information on the approval such as the type and the performance of the substrate and the number of approval, the name and the location of the works or the building, the name of the person in charge of the working and the person in charge of the issuance. When the request for issuance of the approved material certificate and the order for the approved material are received simultaneously, the priority is given to the request for the issuance. In the current situation, since a certificate which has the seal of the company and is effective for the period of one month must be submitted for the inspection by the fire department at the location of completion of the working, it is inevitable that the certificate be issued and sent manually. However, when identification of the person in charge of issuance by a computer is made possible in future and the rule is changed, the certificate can be issued through the internet.

In the method of the present invention, when the request for issuance of the approved material certificate is received from a customer having the ID number and the password, the amount of inventory of the approved sheet material in the customer and the amount of the approved sheet material used by the customer are checked by the computer and, when the used amount exceeds the amount of inventory, a signal of disapproving the issuance of the approved material certificate is output. Since it is a very unusual situation that the used amount exceeds the amount of inventory and the signal of disapproving the issuance of the approved material certificate is output, the person in charge of the case in the manufacturer of the approved sheet material can immediately visit the customer and investigate the actual condition.

In the method of the present invention, a certificate label can be issued together with the approved material certificate based on the request by the customer. The issuance of the certificate label can be requested simultaneously with the request for issuance of the approved material certificate through the network communication. It is confirmed by the output of the signal of approving the issuance of the approved material certificate that the approved sheet material is used normally by the customer, and the certificate label can be issued without any problems. The customer who receives the issued certificate label can affix the certificate label to the interior material at the location of the working to clearly show that the used interior material is the approved material.

In the method of the present invention, when the first order from a customer is received, an ID number and a password are provided to the customer. The approved sheet material can be forwarded, and the forwarded amount can be input into the computer. When the first order from the customer is made through a network communication, information on the customer such as the name, the address and the telephone number of the company are input into the computer simultaneously with the receipt of the order. The ID number and the password provided to the customer can be placed into the package together with the approved sheet material and sent to the customer. The customer inputs the ID number and the password found in the package of the approved sheet material through the page of approval and registration on the network communication such as the internet and is registered as the customer using the approved sheet material when the customer accepts the requirements by the manufacturer of the approved sheet material (such as the designated printer, the designated ink and the method of working) shown on the display.

When the first order from the customer is made using a facsimile or through an agent, a temporary ID number and a temporary password provided to the customer can be placed into the package together with the approved sheet material and sent to the customer. The customer who receives the temporary ID number and the temporary password found in the package of the approved sheet material inputs the information of the customer such as the name, the address and the telephone number of the company in combination with the temporary ID number and the temporary password through the network communication and accepts the requirements by the manufacturer of the approved sheet material. After these procedures, the regular ID number and the regular password are provided to the customer, and the customer is registered as the customer using the approved sheet material.

In the present invention, the manufacturer of the approved sheet material can accumulate in a file additional information such as newer information on the output of the approved sheet material and the working using the approved sheet material, new products and changes in laws and rules. The registered customer can access the file by inputting the ID number and the password to obtain useful information.

In accordance with the method of the present invention, data on the actual sales and the actual use of the approved sheet material can be accumulated in the computer and, when information on the use of the approved sheet material in the past is requested, the search on the information and the response to the request can be made quickly.

For the approval of a material by a public organization, great amounts of labor, time and expense are required in requesting the test of performance evaluation by a specific organization for the performance evaluation and in requesting the approval to the public organization, and it is not easy that each customer obtain the approval individually. In accordance with the method of the present invention, the approval obtained by the manufacturer of the sheet material can be shared and used easily by many customers through the network communication such as the internet.

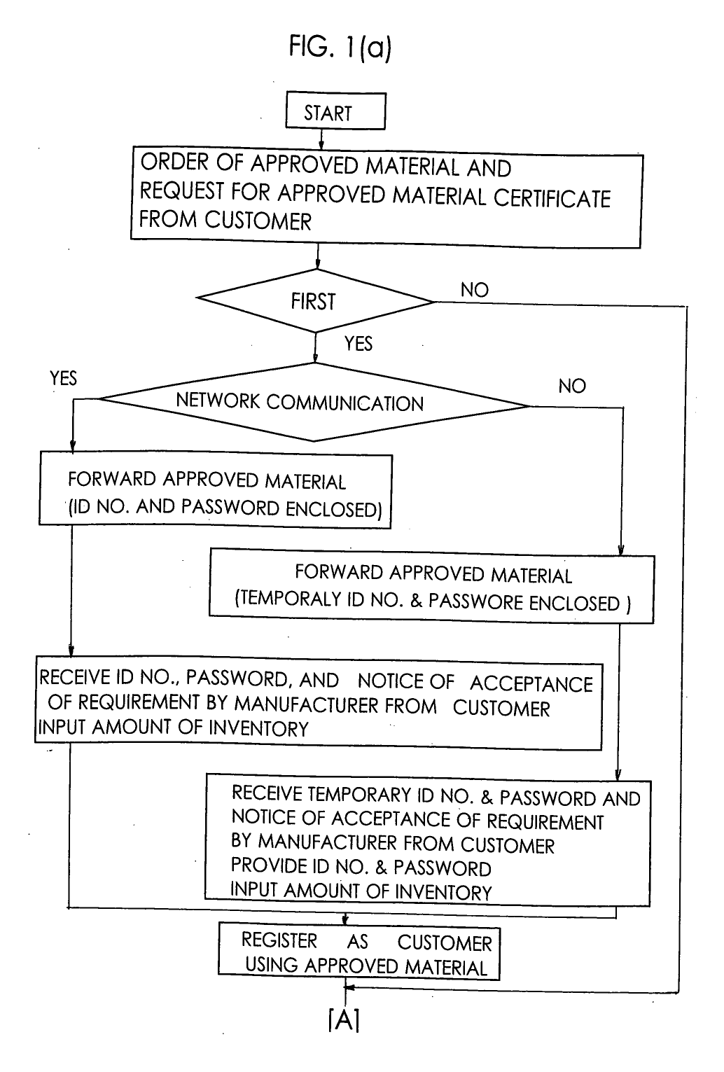

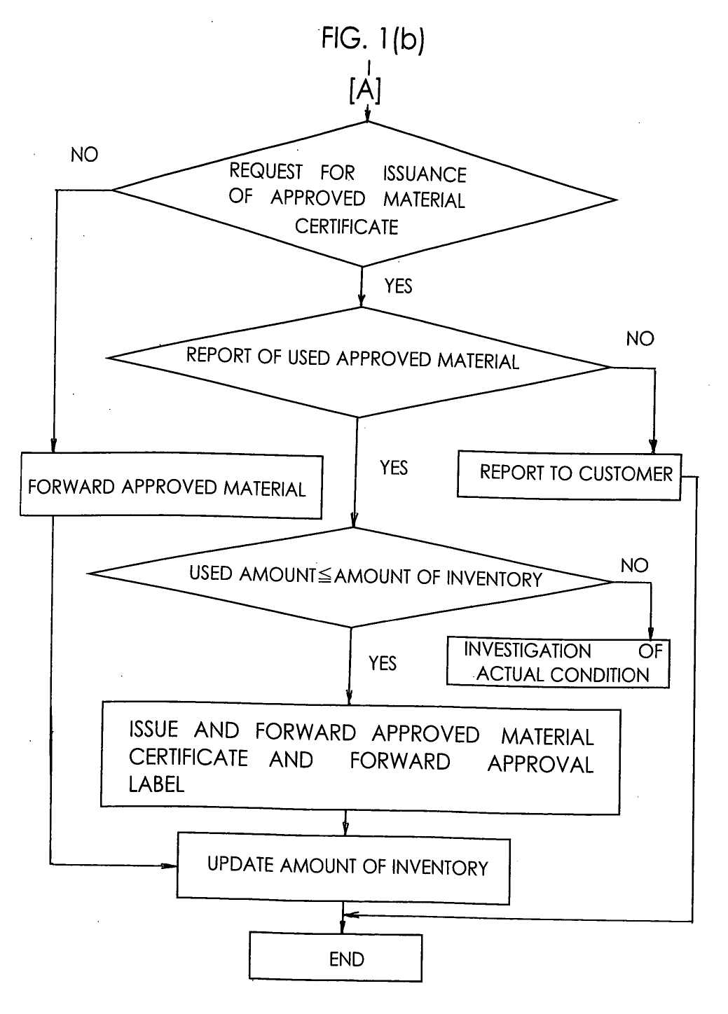

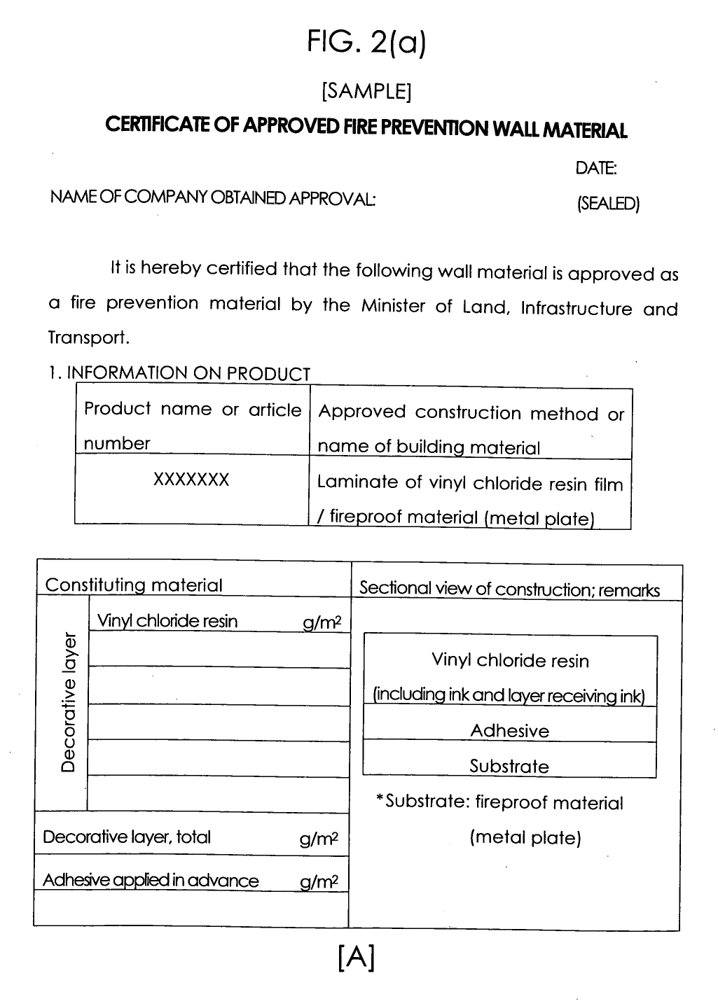

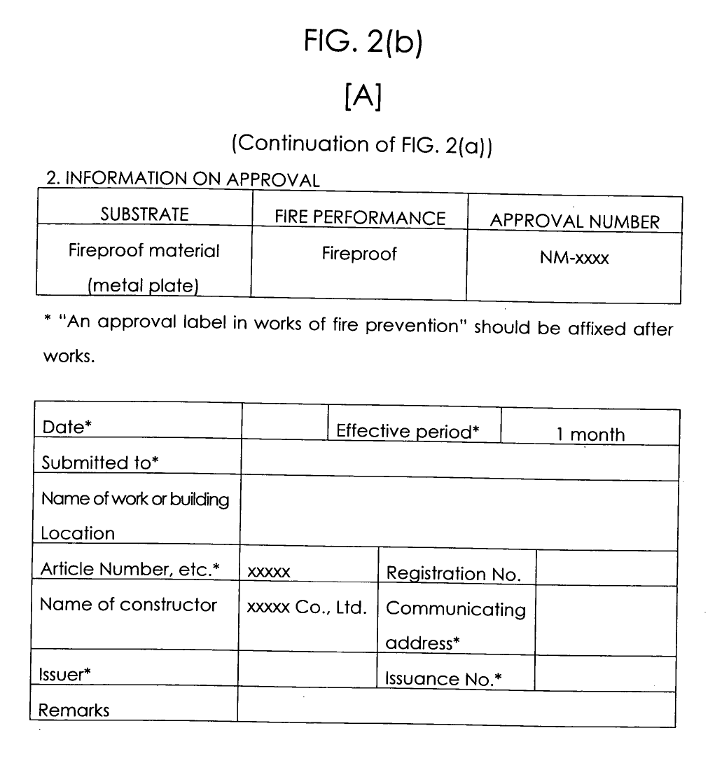

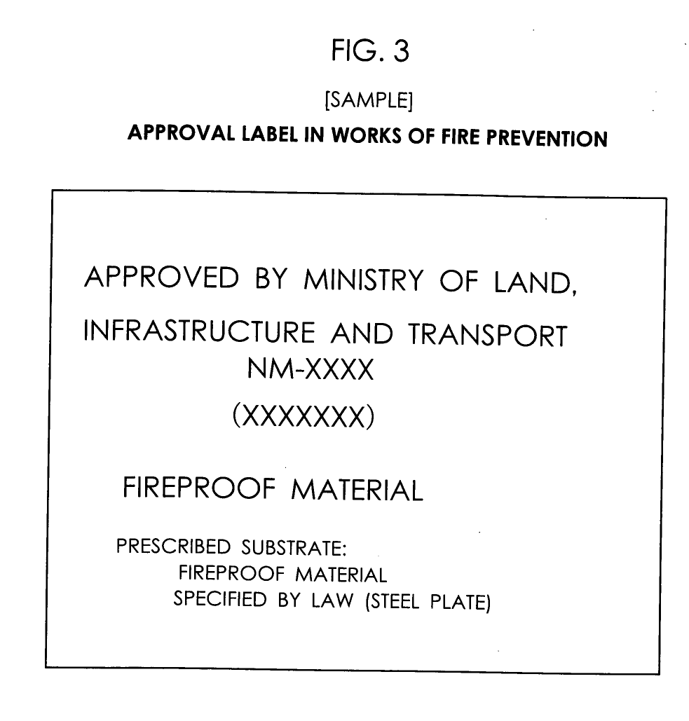

FIG. 1 shows a flow diagram of an embodiment of the method of the present invention.

To summarize the advantages obtained by the invention, in accordance with the method for selling an approved material of the present invention, when a material approved by a public organization such as wall materials and interior materials approved with respect to the fire prevention or the flame resistance is sold, a request for issuance of the approved material certificate is received through a network communication, the amount of inventory in the customer and the amount used by the customer are checked, and approval or disapproval of the issuance of the approved material certificate is decided quickly and accurately.

### EXAMPLES

The present invention will be described more specifically with reference to an example in the following. However, the present invention is not limited to the example.

### Example 1

The method of the present invention was tentatively conducted with a customer with whom the trade connection had been held for a long time.

An order for an approved fire prevention material from the customer was received, and 30 m of a sheet material and 30 m of a protective film were sent with an ID number and a password in the same package on May 30. On June 2, the ID number and the password were sent from the customer, and the types of the ink jet printer and the laminator owned by the customer were confirmed. The requirements by the manufacturer were accepted. This customer was registered as the customer using the approved fire prevention material, and the amount of inventory in the customer was input into a computer.

On June 10, a report of the use of 20 m of the sheet material and 25 m of the protective film, a request for issuance of the approved fire prevention material certificate and a request for issuance of an approval label in works of fire prevention using the fireproof material were received. It was decided by the computer that the amounts of the materials used by the customer did not exceed the amounts of inventory in the customer. The signal for approval of the issuance of the approved fire prevention material certificate was output, and the amount of inventory was updated. The approved material certificate shown in FIG. 2(a) and FIG. 2(b) was issued manually and sent to the customer together with the approval label shown in FIG. 3 via the registered mail.

On June 16, an order for 30 m of the same sheet material and the same protective film from the customer was received through the internet, and the ordered material and film were sent out within the same day. The amount of inventory in the computer was automatically updated.

On June 20, a report of the use of 20 m of the sheet material and 25 m of the protective film, a request for issuance of the approved fire prevention material certificate and a request for issuance of the approval label in works of fire prevention from the customer were received through the internet. It was decided by the computer that the amounts of the materials used by the customer did not exceed the amounts of inventory. The signal for approval of the issuance of the approved fire prevention material certificate was output, and the amount of inventory was updated. The approved material certificate was issued manually in a manner similar to that described above and sent to the customer together with the approval label in works of fire prevention via the registered mail.

By the tentative operation described above, it was confirmed that the method for selling the approved material of the present invention functioned efficiently.

1. A method for selling an approved material which comprises, using a computer for inputting an amount of the approved material forwarded to a customer and an amount of the approved material used by the customer with respect to every customer and every brand and recording an updated amount of inventory of the approved material in the customer,
when a request for issuance of an approved material certificate is received from a customer having an ID number and a password through a network communication, checking an amount of inventory of the approved material in the customer and an amount of the approved material used by the customer by the computer;
when the amount used by the customer does not exceed the amount of inventory, outputting a signal of approving the issuance of the approved material certificate, and recording an updated amount of inventory which is obtained by subtracting the amount used by the customer from the amount of inventory; and
when the used amount exceeds the amount of inventory, outputting a signal of disapproving the issuance of the approved material certificate.

2. A method for selling an approved material according to claim 1, wherein the approved material is a fire prevention material conforming to a building standard of an organization.

3. A method for selling an approved material according to claim 2, wherein the building standard is the Japanese Building Standards Act.

4. A method for selling an approved material according to claim 1, wherein the approved material is a flame resistant material conforming to a fire protection law.

5. A method for selling an approved material according to claim 4, wherein the fire protection law is the Japanese Fire Protection Law.

6. A method for selling an approved material according to claim 1, wherein the approved material is a material preventing Sick House Syndrome conforming to a building standard.

7. A method for selling an approved material according to claim 6, wherein the building standard is the Japanese Building Standards Act.

8. A method for selling an approved material according to claim 1, wherein the approved material is a material having an assured quality based on a rule in a company.

9. A method for selling an approved material according to claim 1, wherein, when a first order is received from a customer, an ID number and a password are provided to the customer, the approved material is forwarded to the customer, and an amount forwarded to the customer is recorded in the computer.

10. A method for selling an approved material according to claim 1, wherein the approved material is a material used for digital prints.

11. A method for selling an approved material according to claim 2, wherein the approved material is a material used for digital prints.

12. A method for selling an approved material according to claim 4, wherein the approved material is a material used for digital prints.

13. A method for selling an approved material according to claim 6, wherein the approved material is a material used for digital prints.

14. A method for selling an approved material according to claim 8, wherein the approved material is a material used for digital prints.

15. A method for selling an approved material according to claim 9, wherein the approved material is a material used for digital prints.

16. A method for selling an approved material according to claim 1, wherein the approved material is a sheet material.

17. A method for selling an approved material according to claim 2, wherein the approved material is a sheet material.

18. A method for selling an approved material according to claim 4, wherein the approved material is a sheet material.

19. A method for selling an approved material according to claim 6, wherein the approved material is a sheet material.

20. A method for selling an approved material according to claim 8, wherein the approved material is a sheet material.

21. A method for selling an approved material according to claim 9, wherein the approved material is a sheet material.

22. A method for selling an approved material according to claim 10, wherein the approved material is a sheet material.
